(19) United States
(12) Patent Application Publication
(10) Pub. No.: US 2007/0224966 A1
(43) Pub. Date: Sep. 27, 2007

(54) Emergency wireless phone system

(76) Inventor: Michael Patrick Flynn, Santa Ana, CA (US)

Correspondence Address: LEWIS, BRISBOIS, BISGAARD & SMITH LLP, 221 NORTH FIGUEROA STREET, SUITE 1200, LOS ANGELES, CA, 90012, US

(21) Appl. No.: 11/726,871

(22) Filed: Mar. 23, 2007

Related U.S. Application Data
(60) Provisional application No. 60/785,715, filed on Mar. 24, 2006.

(51) Int. Cl. H04M 11/04

(52) U.S. Cl. 455/404.1

(57) ABSTRACT

A system for emergency wireless call communication in a geographical area having a plurality of wireless communication carriers comprising, a communications handset that operates on all carriers and apparatus to transfer the call to the carrier which has the best available reception.

This application claims the benefit of U.S. Provisional Application Ser. No. 60/785,715, filed Mar. 24, 2006, which application is incorporated herein by reference in its entirety.

### FIELD OF THE INVENTION

This invention comprises a wireless phone system for emergency wireless call communication.

### BACKGROUND OF THE INVENTION

Wireless communication suffers from the problem of dropped calls and poor reception due to manner in which it operates, with cell tower locations being scattered. With several system carriers providing service, one carrier may have better service in a certain geographical area and another carrier better services in another area.

This is a serious problem when dealing with emergency services, such as police, fire and medical. If their calls are dropped or reception is not clear, serious results can occur. A need exists to create a system which utilizes existing equipment in a manner which maximizes the quality of emergency calls, so that rapid, uninterrupted communication is achieved.

### BRIEF DESCRIPTION OF THE INVENTION

This invention comprises a system that allows a single handset (phone/text messaging) to work on all network frequencies (even satellite). Any user, such as an emergency worker, could initiate a call or walkie-talkie call and the system would determine the coverage of each carrier to determine which carrier's wireless site/frequency had the best coverage for the call. This would allow the user/emergency service to have the best available coverage.

The system can be programmed to have emergency departments “grouped” by number, allowing for a hierarchy national system for emergency communications by departments and geographic locations that are coded. For example, Fire Departments could start with 8, Police with 5, plus area code. The directory would then add the city, etc. The system has specialized handsets and network hardware/software to handle the technology.

Municipalities and government agencies could sign up for the system. A new company would have contracts for service from each of the carriers within a marketplace. Each marketplace could have different providers running different technologies. All frequencies within a marketplace could be included. The system preferably utilizes up to all of the carriers in a marketplace. Today, there are Multi-Mode phones that individual carriers use, but no system by which all the various carrier systems are linked, to provide an “All Mode Cross-Carrier Phone and Service” managed for emergency services.

### BRIEF DESCRIPTION OF THE DRAWINGS

FIG. 1 is a flow diagram using an automatic handset;

FIG. 2 is a flow diagram using a manual handset; and,

FIG. 3 is a flow diagram of the call switching.

### DETAILED DESCRIPTION OF THE INVENTION

This invention comprises a set of emergency numbers that are put into all the carrier's switches. If an emergency call is made, the system utilizes the usual carrier for that phone, but if there is no coverage available or reception is poor, either there is a manual switch between networks or the phone system immediately and automatically switches the call to the carrier having the best coverage for the call. If the coverage changes during the call, the system would again switch the call to the carrier having the best available coverage. In this manner, emergency calls would rarely be lost.

A hierarchy is set up to determine when a phone moves between networks, by setting thresholds. This would apply in cases where there are multiple cell sites in close proximity. It is not practical to have the handset handing off the call within a few feet of duplicate or close proximity cell sites. The system is set up with a primary carrier and the phone switches over if the call or decibel (db) level of the coverage drops below a certain level, such as 90 db, or if the call is dropped due to capacity blocking or non-sufficient coverage.

The phones will operate in, and be manufactured to operate, by geographic areas, where certain carriers operate. The phone takes the available network and makes/receives the call. The key element is making the handset with the appropriate frequencies.

In one embodiment, the handset would be able to manually move between networks, yet only work on the chosen network. The more advanced handset automatically moves from one network to another. This is done by either having a single number for all networks or a different number with each carrier and the ability to transfer to a new number when required.

The phone would have the ability to move across networks during a call. The Allocated Numbers, or user identification numbers, recognized by the carriers in the area, would be in each of the carrier's networks, allowing the call to move, not only between cell sites with the same carrier, but between carriers with the same technology (roaming today) and carriers with different technologies.

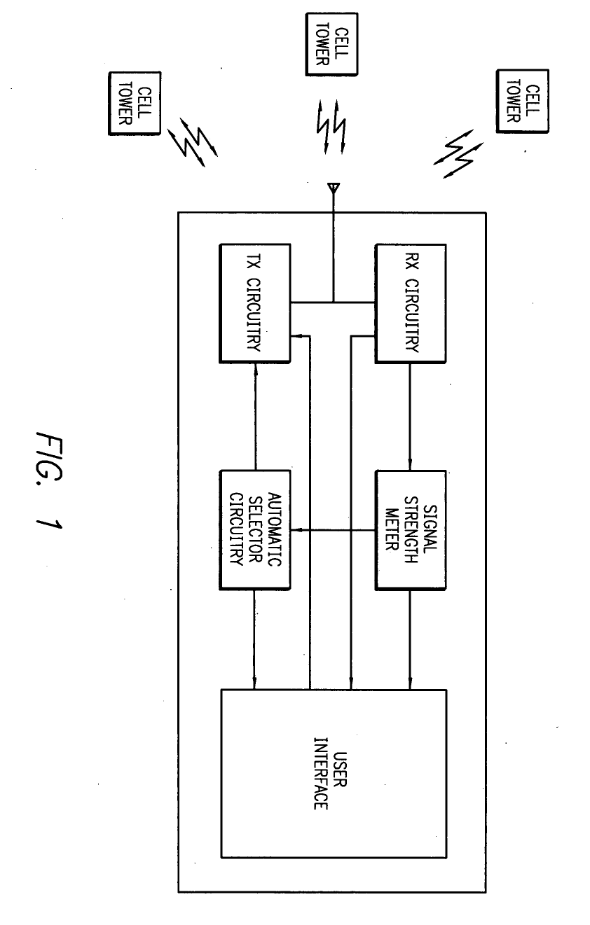

Referring to FIG. 1, the preferred embodiment is a phone that uses a single number that is registered with all the participating carriers via the carrier's control channels. The phone contains software which chooses which carrier's network is being used, based on the threshold criteria, based upon the best reception, as stated above. Rx is the receiver and Tx is the transmitter. The open triangle is an antenna.

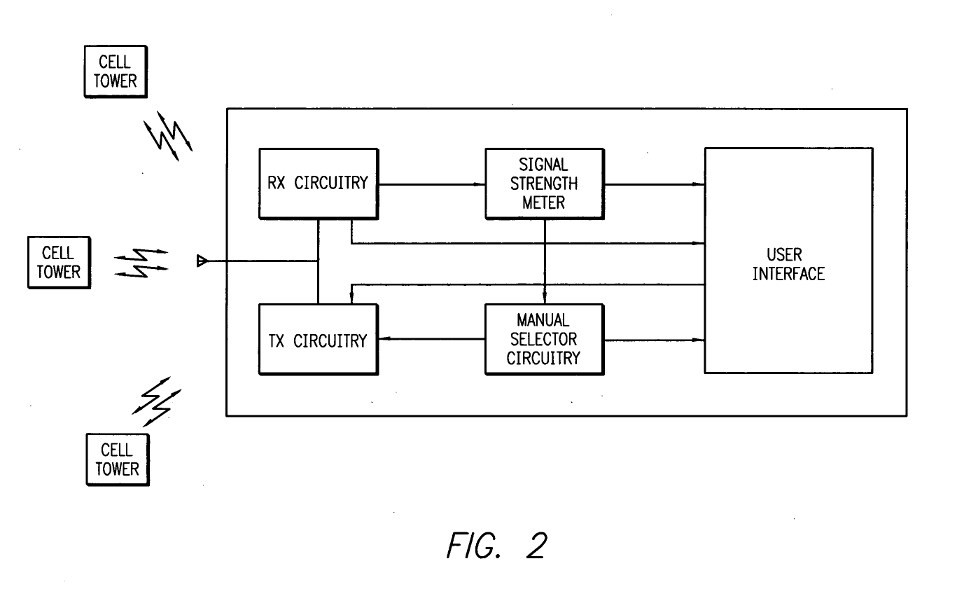

Referring to FIG. 2, the handset has a different phone number for each carrier. The emergency handset has the ability to choose the network with the best available reception and place an emergency call on that carrier's network, while placing or setting up simultaneous calls on other networks for a possible hand-over of the call. The phone would hand-over the call in progress, seamlessly.

One way to accomplish the hand-over result is with a “three way call”. When the handset establishes the second carrier network connection, the handset terminates the first call. This scenario can be played out for as many carrier networks as are available. Also, various Roaming Agreements may be used to allow a single number to be recognized on multiple carrier networks. This may also enhance having the handset move between networks.

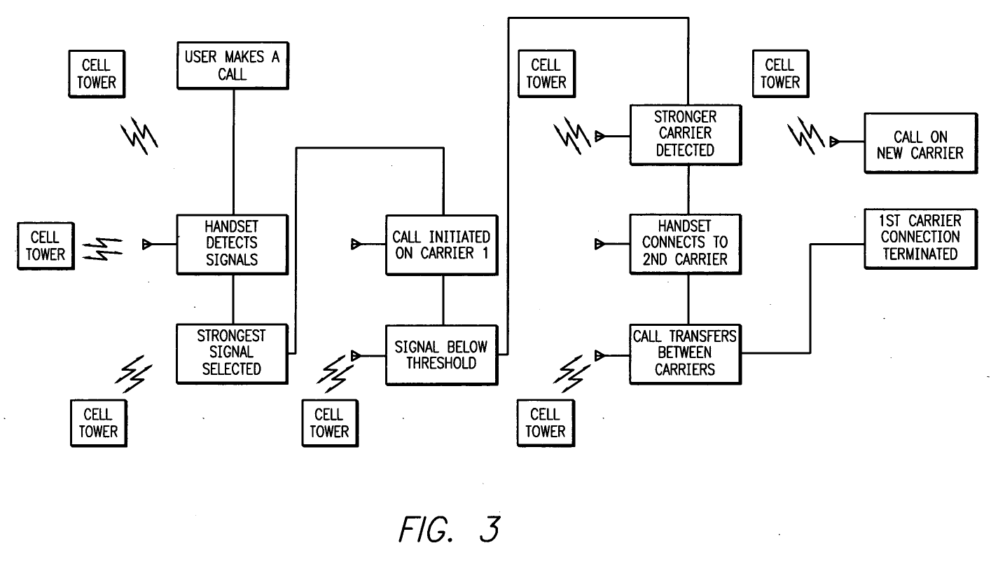

Referring to FIG. 3, there is shown the steps in transferring a call between networks when the signal falls below a certain set threshold. The handset detects a carrier with a stronger signal, connects to that carrier, transfers the call and then disconnects from the first carrier.

The system can be set up so that all emergency calls have “first responder” priority through the carriers, which would eliminate blocking as the phone places calls.

The phone can incorporate additional features such as data services for SMS, Internet connection, both traditional voice and VOIP, Push to Talk, GPS, and an Emergency Service Band used by current emergency service agencies.

The creation of a national spectrum, now being discussed for emergency services, would provide an additional method for emergency calls but it would be beneficial to have the ability to have commercial carriers also available in an area that may be damaged in a disaster or an area where service simply does not exist.

Logistically, a new company would be set up to have the phone numbers allocated and the ability to bill for the calls by aggregating the calls onto a single bill for each Emergency Provider. This way the emergency responder (government agency or private provider) would be able to make and receive calls on the best carrier network.

Having thus described the invention, I claim:

1. A system for emergency wireless call communication in a: geographical area having a plurality of wireless communication carriers comprising, a communications handset that operates on all carriers and means to transfer the call to the carrier having the best available reception.

2. The system of claim 1 in which the handset automatically transfers the call to the provider which has the best available reception.

3. The system of claim 1 in which the handset comprises means to manually transfer the call from one carrier to another.

4. The system of claim 1 in which the call is initially placed with the usual carrier for the handset and then transferred to the carrier which has the best reception.

5. The system of claim 1 further comprising three-way calling to effectuate the transfer to the carrier with the best reception.

6. The system of claim 1 in which the handset has a single access number, which operates on all carriers.

7. The system of claim 1 in which the handset has a different access number for each carrier.

8. The system of claim 1 in which a different access number is used for each emergency service provider.

9. The system of claim 8 in which the emergency service providers are police, fire and medical.

10. The system of claim 1 in which the call is transferred based upon predetermined criteria.

11. The system of claim 10 in which the predetermined criteria is the decibel level of the call.

12. The system of claim 11 in which the decibel level at which the call is transferred is 90 db.

13. The system of claim 1 in which the call is transferred if the call is dropped, is blocked due to lack of capacity or due to non-sufficient coverage.

14. The system of claim 1 in which the handset has the ability to choose the network with the best available reception and place an emergency call on that carrier's network while placing or setting up simultaneous calls on other networks for a possible transfer of the call.

15. The system of claim 1 in which emergency calls have first responder priority with all carriers.

16. A method of doing business comprising a single business entity having the ownership of a plurality of emergency wireless communication numbers, for emergency service providers, the business entity billing each emergency service provider for all emergency calls placed by the emergency service provider using the wireless communication numbers.

17. A system for emergency wireless call communication in a geographical area having a plurality of wireless communication carriers comprising, a communications handset that operates on all carriers and apparatus to transfer the call to the carrier having the best available reception.

18. The system of claim 17 in which the apparatus comprises a signal strength detector.
